(19) United States
(12) Patent Application Publication
(10) Pub. No.: US 2025/0314351 A1
(43) Pub. Date: Oct. 9, 2025

(54) OIL DRAINAGE AND SHIELDING DEVICE FOR MOTOR VEHICLES

(71) Applicants: Adam Rzadkowolski, Lake Orion, MI (US); Bill Rzadkowolski, Oxford, MI (US)

(72) Inventors: Adam Rzadkowolski, Lake Orion, MI (US); Bill Rzadkowolski, Oxford, MI (US)

(21) Appl. No.: 19/172,153

(22) Filed: Apr. 7, 2025

Related U.S. Application Data
(60) Provisional application No. 63/631,634, filed on Apr. 9, 2024.

(51) Int. Cl. F16N 31/00

(52) U.S. Cl. CPC F16N 31/004

(57) ABSTRACT

An oil capturing device for a motor vehicle is disclosed, may include a handle that functions as a channel for fluid flow, facilitating the easy pouring out of collected oil. The device may include an open top with a face on one side, serving as a shield to protect an user and surrounding components from oil discharge during the draining process. The design may include a partial cutout in the Z-axis, creating a higher plane above a top of the body to act as a shield and a guide for positioning the device at the oil draining orifice.

### CROSS-REFERENCE TO RELATED APPLICATIONS

This application claims the benefit of U.S. Provisional Application No. 63/631,634, filed on Apr. 9, 2024. The entire disclosure of the above application is incorporated herein by reference.

### FIELD

The present technology relates to devices for capturing and containing fluids and, more particularly, collecting used oil during a maintenance procedures of a motor vehicle.

### INTRODUCTION

This section provides background information related to the present disclosure which is not necessarily prior art.

The process of changing motor oil in vehicles may involve the collection of used oil, which may be a messy and environmentally hazardous task. One way to collect used oil may employ a receptacle such as a pan, a tank, and a funnel to capture draining oil from a vehicle. The receptacle may be placed beneath a vehicle oil draining orifice, relying on gravity to direct the flow of oil into the receptacle. However, this may result in oil spillage and contamination of a workspace from an uncontrolled flow of oil to the receptacle.

An issue with certain oil collection systems relates to their static nature. The collection systems may remain in a single place below the vehicle, which may lead to oil splashing and spill as the oil travels from the draining orifice to the receptacle. This issue may be compounded when obstructions are present between the draining orifice and the collection device. Scattered oil may create a mess and a risk of environmental contamination while requiring additional cleanup.

Oil collection system may also lack features to address the handling of hot oil. For example, materials used in construction of a pan, tank, or funnel may not be configured to withstand the temperature of hot motor oil. This may lead to warping or melting of the receptacle, resulting in a leak or spill that may result in a mess, in addition to rendering the receptacle unfit for further use. Moreover, a lack of integration between the oil collection function and the disposal or storage of the used oil may often require an user to transfer used oil from the collection receptacle to a separate container for disposal. This additional step not only increases the time required to complete an oil change but also heightens the risk of a spill and contact with the used oil.

As such, there is a continuing need for an oil collection system that minimizes spillage and environmental impact, enhances the efficiency of the oil change process, and provides a solution for the collection, temporary storage, and disposal of used motor oil.

### SUMMARY

In concordance with the instant disclosure, an oil collection system that minimizes spillage and environmental impact, enhances the efficiency of the oil change process, and provides a solution for the collection, temporary storage, and disposal of used motor oil, has surprisingly been discovered.

The present technology includes articles of manufacture, systems, and processes that relate to the collection, containment, and disposal of used motor vehicle fluids. Specifically, the present technology pertains to devices designed to improve the efficiency and cleanliness of an oil change procedure, while also addressing environmental concerns and user safety, thereby reducing the potential for spills, contamination, and direct contact with hazardous materials.

In certain embodiments, an oil shield device may include a body component. The body may have an open top formed within it to provide an access to an interior chamber. The device may further include a hollow handle to provide a channel for fluid flow and a spout disposed adjacent to the face. As shown in the drawings, the spout may include an indentation or protrusion for easier pouring. A flat base may provide stability. The body may further include a measurement marking and be transparent to allow a visual inspection of collected oil.

In certain embodiments, a method for using an oil shield during a motor vehicle oil change may include providing an oil shield that includes a body formed from heat-resistant polycarbonate material. The method may also include positioning the oil shield beneath an oil draining orifice of a motor vehicle, and capturing discharged oil through an open top of the oil shield. Oil splatter may be shielded using a face disposed on a side of the open top and directing flow of captured oil through a hollow handle. The oil level may be monitored through the body and measured with a measurement marking on the body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is front perspective view illustrating an oil shield, according to an embodiment of the present disclosure.

FIG. 2 is a side perspective view of the oil shield shown in FIG. 1, according to an embodiment of the present disclosure.

FIG. 3 is a side elevational view of a water jug prior to formation into an oil shield, according to an embodiment of the present disclosure.

FIG. 4 is a side perspective view of the oil shield formed from the water jug of FIG. 3, according to a further embodiment of the present disclosure.

FIG. 5 is a side perspective view of another oil shield, including a configuration for limited vehicle clearance applications, according to an embodiment of the present disclosure.

FIG. 6 is a side perspective view of the oil shield, including the configuration for limited vehicle clearance applications, according to a further embodiment of the present disclosure.

FIG. 7 is front top perspective view illustrating an oil shield, including the configuration configured for limited vehicle clearance applications, according to an embodiment of the present disclosure.

FIG. 8 is a flowchart illustrating a method of utilizing an oil shield device during an oil change procedure, according to an embodiment of the present disclosure.

FIG. 9 is a flowchart illustrating a method of manufacturing an oil shield device, according to another embodiment of the present disclosure.

FIG. 10 is a flowchart illustrating a method of utilizing an oil shield device during an oil change procedure, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology provides effective, user-friendly, and environmentally responsible approaches to managing drainage, a collection, and a disposal of used motor oil during a vehicle maintenance procedure. The present technology may include a device including a handle, a pour spout including an indentation or protrusion for pouring, and a measurement through a side increment, with a see-through construction that may improve a visibility of oil within the device. The present technology may also include a shielding for oil spray and a heat resistant plastic for enhanced durability and stability when in contact with hot oil. A space-saving shorter form may be configured for limited vehicle clearance while an alternative embodiment may include a taller side design for increased capacity.

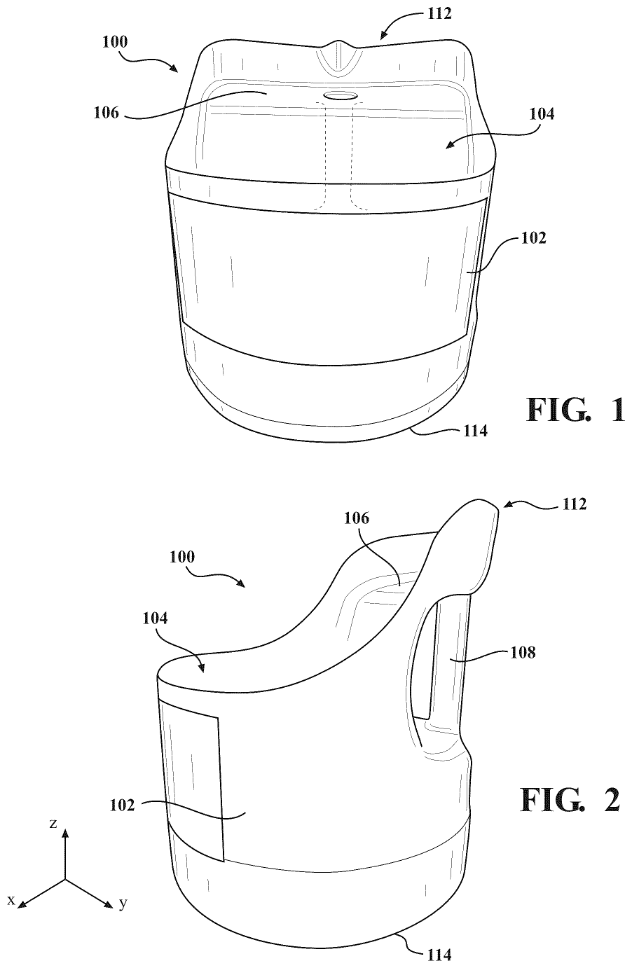

As shown within FIGS. 1-7, an oil shield device may be configured to facilitate an oil change process in a motor vehicle. As shown generally in accompanying FIGS. 1-2, the oil shield device 100 may include a body 102, an open top 104, an extended face 106, that extends above a main portion or lip of the body 102, and a handle 108.

The body 102 of the oil shield device 100 may be constructed from a heat resistant and durable material. For example, the oil shield device 100 may include a polycarbonate or polyolefin material or similar material that is clear and/or semi-clear. Advantageously, use of polycarbonate material may provide high heat tolerance and durability. This material may enable the oil shield device 100 to withstand a temperatures of hot oil that may occur during a routine motor vehicle maintenance without deforming or compromising the structural integrity of the oil shield device 100. The polycarbonate material of the body 102 may also be transparent or translucent. A transparency of the polycarbonate material of the body 102 may enable a visual inspection of the oil, enabling the user to detect contaminants or irregularity in the oil without additional tools or equipment. The ability to visually inspect the collected oil may be beneficial in diagnosing potential engine issues. Advantageously, the transparency of the polycarbonate material of the body 102 may also allow the user to visually detect the amount of oil drained into the body 102 to militate against overflow of the body 102 with oil during the oil change process. The body 102 may also be configured to catch drain plugs, filters, and gaskets, and the like.

With reference to FIGS. 1 and 2, the body 102 of the oil shield device 100 may include the open top 104 for collection of oil as the oil is drained from a vehicle. The open top 104 may further include an extended face 106 on one side that extends above a side of body 102. The extended face 106 may serve as a protective barrier. In particular, the extended face 106 may be configured to prevent oil splashes and spills, as oil enters the oil shield device 100, thereby maintaining a cleaner work environment and reducing risk of oil waste.

The oil shield device 100 may also include the handle 108, which may be hollow, as shown in FIGS. 1 and 2. The handle 108 may be sized to accommodate a hand of a user. Examples of such sizes may include a handle 108 having a one-inch diameter or having greater than one-inch diameter. One of ordinary skill in the art may select suitable dimensions for the handle 108 within the scope of the present disclosure. Advantageously, a hollow feature of the handle 108 may provide an additional channel for fluid flow as the oil fills the inside of the body 102 during an oil change process. In certain embodiments, a larger diameter handle 108 may direct more oil through the handle 108 and a smaller diameter handle 108 may direct less oil through the handle 108. The handle 108 may enable a transition of oil from the body 102 to a disposal container as an user holds the oil shield device 100 in place.

In certain embodiments, the handle 108 may be ergonomically designed to provide a comfortable grip, making it easier for the user to maneuver the oil shield device 100 during the oil change process. The handle 108 may be elongated to allow the user to comfortably hold the handle 108 when the oil shield device 100 is in use. One of ordinary skill in the art may select a handle 108 as appropriately desired and within the scope of the present disclosure. The handle 108 may be formed of the same material as the entirety of the oil shield device 100 or may be formed of a different material than the remainder of the space-saving oil shield device 120. Additionally, the handle 108 may include additional materials, such as gripping materials, heat resistance materials, and other materials known to those of skill in the art to be useful on a device handle.

The oil shield device 100 may be available in different sizes to accommodate different oil volumes. For example, the body 102 of the oil shield device 100 may be sized to accommodate a 3-gallon volume. In certain embodiments, the body 102 of the oil shield device 100 may be sized to accommodate a 5-gallon volume. Such size options may provide versatility for a user, allowing a choice of an appropriate size based on oil capacity of the vehicle and volume of oil expected to drain. Advantageously, the adaptability of the oil shield device 100 may make the oil shield device 100 suitable for a wide range of vehicles, from a small passenger car to a larger commercial vehicle. One of ordinary skill in the art may select an appropriately suitable volume to construct the body 102 within the scope of the present disclosure.

The body 102 of the oil shield device 100 may further include an spout 112, with continued reference to FIGS. 1 and 2. The spout 112 may be molded into the body 102 of the oil shield device 100 and may be manufactured as part of the body 102. More specifically, the spout 112 may be disposed adjacent the extended face 106. The spout 112 may be disposed directly above the extended face 106, as shown in FIGS. 1 and 2, to facilitate the pouring of the oil contained within the body 102. The spout 112 may be configured to control the pouring of the collected oil with a protrusion and/or an indentation within the body 102. Advantageously, the spout 112 may militate against spills and drips during the transfer of oil to a disposal container, further contributing to an environmentally responsible oil change process. The spout 112 may be wide or narrower with a protrusion and/or the indentation as shown in the FIGS. to provide a controlled pouring of the oil during the transfer of the oil to the disposal container. One of ordinary skill in the art may select a suitable spout 112 within the scope of the present disclosure. Advantageously, the spout 112 may militate against a need for additional an additional funnel or tool during an oil change process.

The oil shield device 100 may include a flat base 114. The flat base 114 may be configured to have a circular shape, specifically conforming to the shape of the body 102. One of ordinary skill in the art may select a suitable shape to form the flat base 114 within the scope of the present disclosure. The flat base 114 may provide stability when the oil shield device 100 is placed on a surface. The flat base 114 may be configured to ensure that the oil shield device 100 remains upright and secure, militating against accidental tipping of the oil shield device 100 and militating against the potential for spills. The stability offered by the flat base 114 may be particularly important when the oil shield device 100 is placed on uneven surfaces or during certain weather conditions.

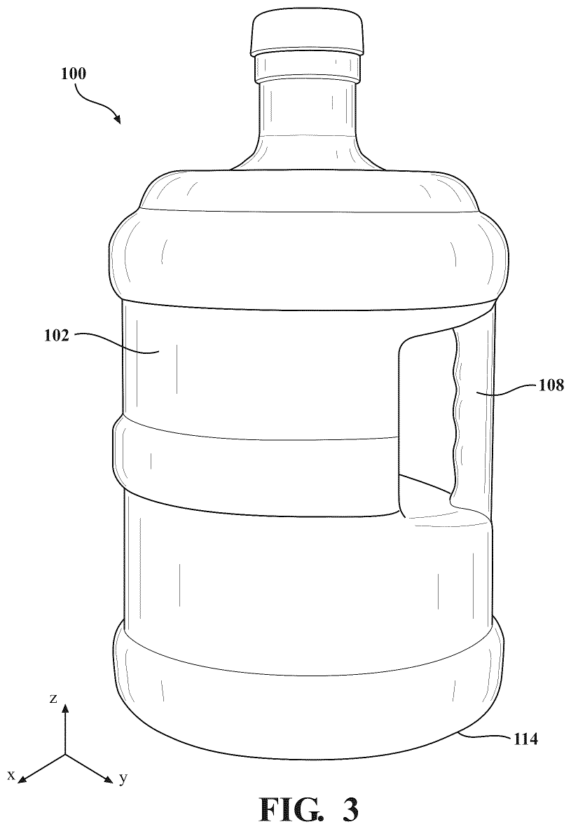

As shown within FIG. 3, the oil shield device 100 may be manufactured using a recycled polycarbonate water bottle. The recycled polycarbonate water bottle as shown in FIG. 3, may form the body 102 and a handle 108 as a base structure. The water bottle structure may undergo modifications to create the oil shield device features. The initial water bottle form may provide an environmentally sustainable material source while delivering the required heat-resistant properties. The recycled polycarbonate water bottle may form a complete structure including the body 102 and handle 108 through an environmentally sustainable manufacturing method. The recycled material may undergo preparation processes to ensure proper heat resistance properties are maintained throughout the structure. The handle 108 may be formed as part of the original water bottle structure, reducing manufacturing complexity and material waste. The recycled polycarbonate water bottle structure as shown in FIG. 3 may maintain transparent properties through a recycling and a forming processes to enable visual monitoring of collected oil. The handle 108 formation may utilize the existing bottle structure to create the hollow channel for fluid flow.

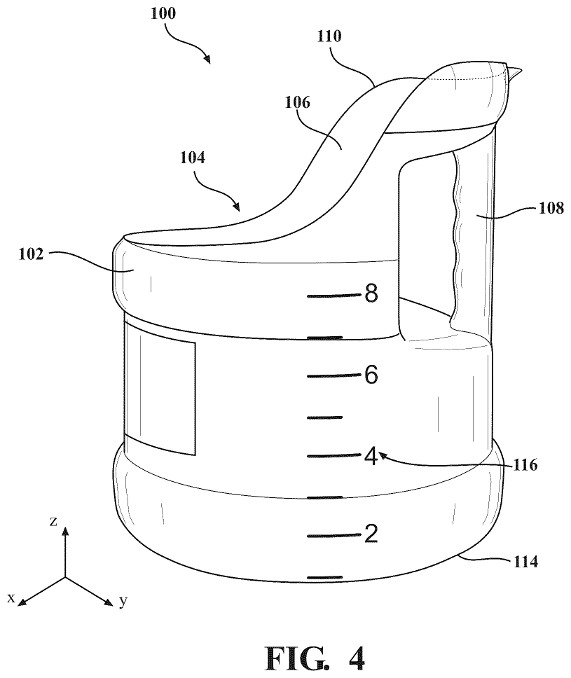

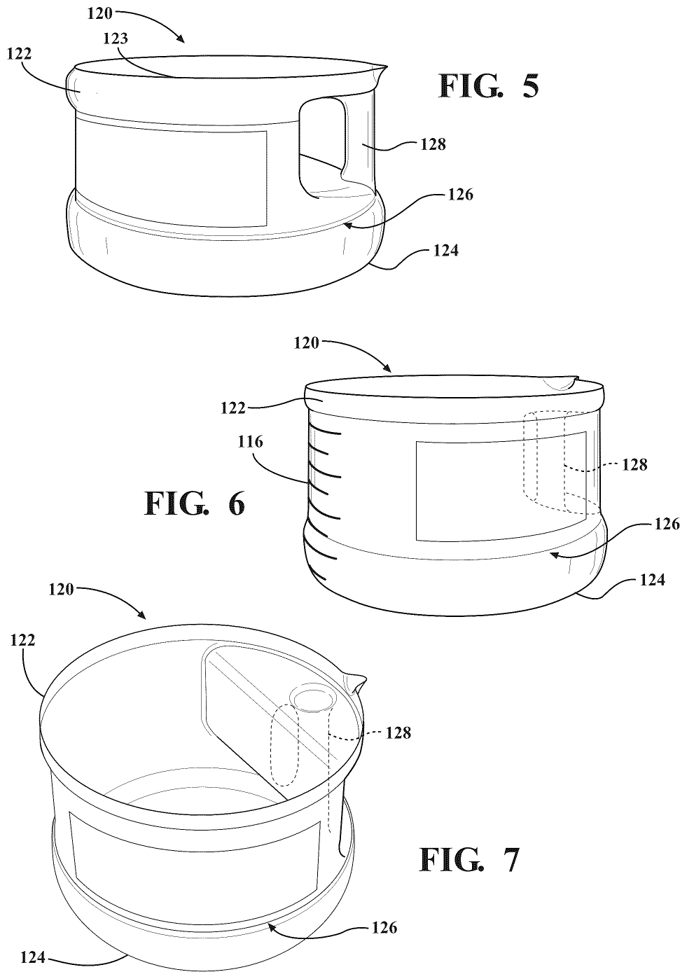

With reference to FIG. 4, an oil shield device 100 may be formed from the polycarbonate water bottle as shown in FIG. 3. As shown in FIG. 4, the body 102 may include an open top 104, such as described above, and including the extended face 106 on one side that extends above a side of body 102. The extended face 106 may serve as a protective barrier. The body 102 and extended face 106 may also be formed by a partial cutout 110 of the water bottle, in order to form the extended face 106 above the body 102 that acts as a shield. The partial cutout 110 may be configured to maximize a shielding effect of the extended face 106 while maintaining a strength of the oil shield device 100. The contour and shape of the partial cutout 110 from the water bottle may also contribute to the aesthetic appeal of the oil shield device 100, giving the oil shield device 100 a distinctive appearance. The oil shield device 100 formed from polycarbonate water bottle may also include an open top with a top edge 123 at even height along a circumference of the body 122, without the extended face 106, such as shown in FIGS. 5-7 and described below.

As further shown in FIG. 4, the body 102 may further include a measurement marking 116 disposed on the body 102. The measurement marking 116 may be disposed on a surface of the body 102. For example, the measurement marking 116 may be engraved or embossed on an outer surface of the body 102. The measurement marking 116 may be calibrated to indicate a volume of oil collected, allowing the user to accurately measure and document an amount of oil drained from the vehicle. As an example, the measurement marking 116 may include a certain range of Arabic numerals with units. As another example, the measurement marking 116 may include certain indicia embossed on the body 102 including words such as “fill” or “full”. The measurement marking 116 may be configured for maintaining compliance with disposal regulations and for record-keeping purposes. Advantageously, the measurement marking 116 may assist with the proper disposal of used oil contained within the body 102.

In certain embodiments, such as shown within FIGS. 5-7, a space-saving oil shield device 120 may include a body 122 formed from the heat-resistant polycarbonate material, such as described above, to allow visual inspection of collected oil. The space-saving oil shield device 120 may include a collection area 126, a handle 128, and a measurement marking. The body 122 may include an open top with a top edge 123 at even height along a circumference of the body 122, without the extended face 106, such as described above. The oil shield device 120 may include a flat base 124. The flat base 124 may be configured to have a circular shape, specifically conforming to the shape of the body 122, similar to the flat base 114, such as described above.

With continued reference to FIGS. 5-7, the space-saving oil shield device 120 may include a configuration specifically designed for limited vehicle clearance applications. The compact form of the space-saving oil shield device 120 may maintain functional features similar to the oil shield device 100 while providing a shorter vertical profile. The body 122 may have a diameter and a height to accommodate a tight space beneath a vehicle.

In particular, the configuration may include a compact form without the extended face 106 that may be particularly useful when clearance under the vehicle is limited. The compact form may incorporate a partial cutout in the Z-axis while maintaining the essential shielding and collection capabilities, such as described above. The reduced height profile may enable access to drain plugs in vehicles with low ground clearance. The compact form may serve as an alternative to the standard configuration when workspace constraints exist. A reduced vertical dimension may not compromise the ability of the body 122 to capture and contain oil during a maintenance procedure and may retain the transparent material construction for a visual monitoring of fluid level. Such compact form may particularly benefit a person working on a lower vehicle or those with limited undercarriage access. Additionally, the compact form may include an optimized fluid flow pathway to prevent an overflow despite a smaller vertical dimension. The compact design may therefore maintain a same volume capacity as described above. Further, the shorter profile may enable a user to position the device closer to the oil drain plug, thus reducing the potential for splashing or misdirected flow.

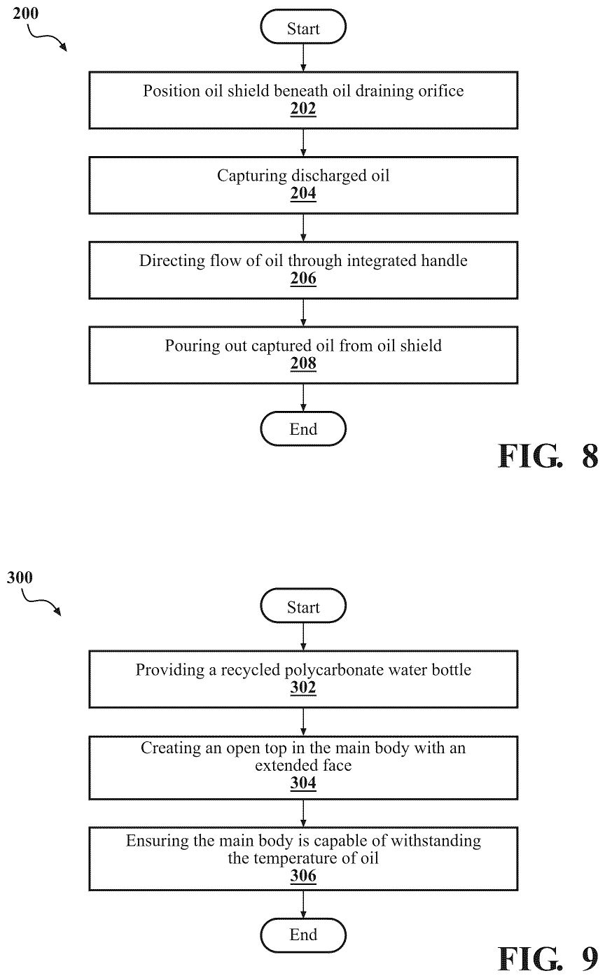

With reference to FIG. 8, a method 200 of using an oil shield device 100 may be contemplated. The method 200 of using the oil shield device 100 may involve a series of steps designed to streamline the oil change process. The method may include a first step 202 of positioning the oil shield device 100 beneath the oil draining orifice of the motor vehicle. The positioning is critical to ensure that the oil flows directly into the oil shield device 100 without spillage. Once the oil shield device 100 is correctly positioned, the method 200 may include a second step 204 of capturing the discharged oil. The open top 104 may collect the discharged oil while the extended face 106 may act as a shield, funneling the oil into the body 102. The handle 108 may allow the user to hold and adjust the position of the oil shield device 100 as needed during this step. The method 200 may further include a third step 206 of directing the flow of the oil through the handle 108, after the oil has been captured within the body 102. The hollow design of the handle 108 serves as a channel, guiding the oil towards the open top 104 for disposal. The method 200 may also include a fourth step 208 of pouring out the captured oil from the oil shield device 100. The spout 112 allows for a controlled and directed flow of oil into a disposal container, militating against the risk of spills and ensuring a clean transfer.

In certain embodiments, a method 300 of manufacturing the oil shield device 100 such as shown in FIG. 9 is contemplated. The method 300 may include a first step 302 of providing a recycled polycarbonate water bottle, as shown in FIG. 3. The material may be sourced from consumer recycling programs, supporting environmental sustainability. More specifically, the first step 302 may include precision molding techniques. The recycled polycarbonate water bottle may include the body 102 and the handle 108, as described herein. As shown in FIG. 3, the recycled polycarbonate water bottle does not include the open top 104. The method 300 may include a second step 304 of creating the open top 104 in the body 102 with the extended face 106. The second step 304 may also include cutting the recycled polycarbonate to form the extended face 106, as well as the open top 104 and partial cutout 110. The method 300 may include a third step 306 of ensuring the body 102 is capable of withstanding the temperature of oil.

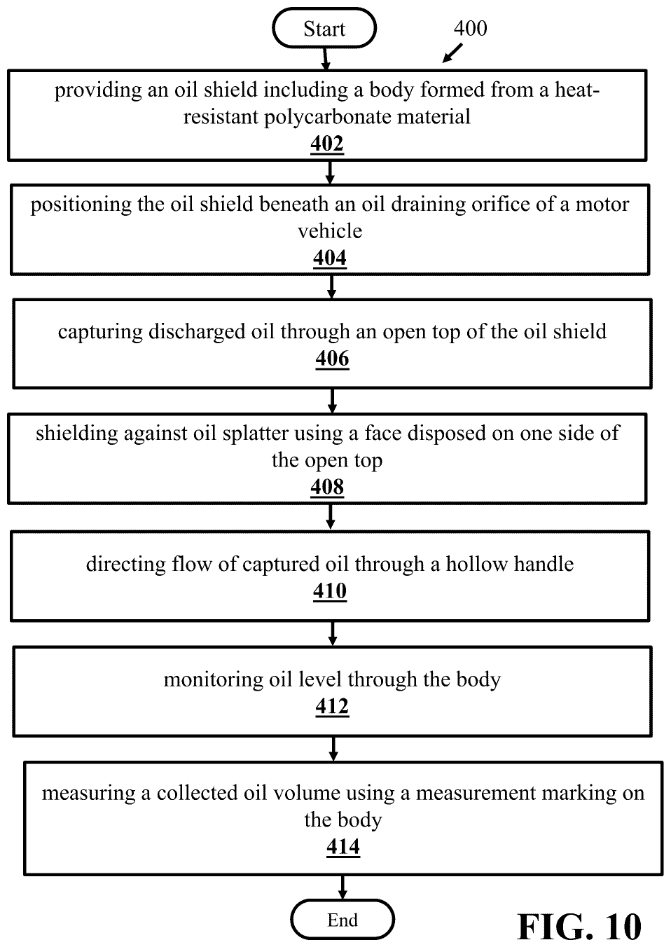

In certain embodiments, such as shown in FIG. 10, a method 400 for using an oil shield device 100, 120 during a motor vehicle oil change may include providing an oil shield device 100, 120 including a body 102, 122 formed from a heat-resistant polycarbonate material in a first step 402. In a second step 404, the oil shield device 100, 120 may be positioned beneath an oil draining orifice of a motor vehicle. Then, in a third step 406, the discharged oil may be captured through an open top of the oil shield device 100, 120. Oil splatter may be shielded against oil splatter using a face disposed on one side of the open top 104 in a step 408 and captured oil may directed through a handle 108, 128 in a step 410. In a step 414 the oil level may be monitored through the body; and in a step 414, the collected oil volume may be measured using a measurement marking on the body.

Advantageously, the oil shield device 100 provides an efficient, clean, and environmentally responsible solution for capturing and disposing of used motor oil. Desirably, the oil shield device 100, with the handle 108 that serves as a channel for fluid flow, allows for a cleaner and more controlled oil change process that requires only one hand. The extended face 106 on one side of the open top 104 acts as a shield, protecting the user and surrounding areas from oil splatter. The use of durable polycarbonate material ensures that the oil shield device 100 may withstand the high temperatures of discharged oil militating against warping or damage. Desirably, the transparency of the polycarbonate material of the body 102 may also allow the user to visually detect the amount of oil drained into the body 102 to militate against overflow of the body 102 with oil during the oil change process. Advantageously, the measurement marking 116 may assist with the proper disposal of used oil contained within the body 102. These improvements collectively contribute to a more efficient, user-friendly, and environmentally conscious approach to motor vehicle maintenance.

### Examples

Example embodiments of the present technology are provided with reference to the several figures enclosed herewith.

### Example: Oil Shield Device Operation and Use

During a vehicle oil change, a user may position the oil shield device beneath an oil draining orifice of a vehicle. An open top may be configured to capture the oil as it is released, while the extended face acts as a protective barrier, shielding the user from any potential splashing or spilling. As an oil drain plug is removed, the oil may begin to flow into the oil shield device. The user observes the oil through the transparency of body of the shield, ensuring that the flow is uninterrupted and that the oil is being collected efficiently. In certain embodiments, an extended face may further militate against oil from splattering onto the user or the surrounding area.

When oil has been fully drained and collected within the oil shield device, the user may use the handle to carefully transport the oil shield to a disposal area. The handle, being hollow, serves as a channel through which the oil may be poured out, eliminating the need for a separate funnel or pouring device. The user may then pour used oil from the oil shield device into a disposal container. A spout of the body may allow a controlled pour of oil, minimizing a risk of spill. After the oil change is complete, a user may clean the oil shield device with ease, due to its polycarbonate material, which may be heat tolerant to oil and other automotive fluids. The oil shield device is then stored away, ready for its next use.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. An oil shield device for capturing oil discharged during a vehicle oil change, comprising:
a body;
an open top formed in the body, the open top configured to provide access to an interior chamber of the body;
a handle formed in the body, wherein the handle is hollow and provides a channel for fluid flow;
a flat base configured to provide stability; and
a measurement marking disposed on the body, wherein the body is transparent to allow visual inspection of collected oil based upon the measurement marking.

2. The oil shield device of claim 1, further including a face disposed on one side of the open top configured to act as a shield for oil run off, the face extending along a Z-axis of the open top.

3. The oil shield device of claim 2, further including a spout disposed on the face.

4. The oil shield device of claim 3, wherein the Z-axis defines a shield height.

5. The oil shield device of claim 1, wherein the body is formed from a recycled polycarbonate water bottle.

6. The oil shield device of claim 1, wherein the open top comprises a top edge at even height along a circumference of the body or an extended face above a top edge of the open top.

7. The oil shield device of claim 1, wherein
the body comprises a transparent polycarbonate material including:
a cutout in a Z-axis comprising:
an extended face above the open top configured to shield against oil splatter, or the open top including a top edge at even height along a circumference of the body;
the hollow handle integrally formed with the body, the hollow handle providing the channel for fluid flow; and
a collection area configured to capture a drain plug, a filter, a gasket and combinations thereof, and that enables a visual monitoring of collected oil through the transparent polycarbonate material.

8. The oil shield device of claim 1, wherein the body is sized to accommodate a three gallon to a five gallon volume.

9. The oil shield device of claim 1, wherein the spout is configured for pouring the collected oil.

10. The oil shield device of claim 1, wherein the flat base has a circular shape conforming to a shape of the body.

11. The oil shield device of claim 1, wherein the measurement marking comprises a plurality of measurement increments on a side of the oil shield device.

12. The oil shield device of claim 10, wherein the measurement marking is embossed on an outer surface of the body.

13. The oil shield device of claim 11, wherein the measurement marking comprises a numerical indicia.

14. The oil shield device of claim 1, further comprising a collection area configured to catch drain plugs, filters and gaskets, and combinations thereof.

15. The oil shield device of claim 1, wherein the body comprises a diameter of eleven inches, a height of thirteen inches, and a partial cutout in a Z-axis.

16. The oil shield device of claim 1, wherein the handle comprises a hollow channel structure, a fluid flow passage, and a nested position.

17. The oil shield device of claim 16, including the hollow channel structure in a nested position within the body.

18. The oil shield device of claim 16, further comprising a spout molded into the body adjacent an extended face above the body, wherein the spout is positioned above the extended face.

19. A method for using an oil shield during a motor vehicle oil change, comprising:
providing an oil shield including a body formed from a heat-resistant polycarbonate material;
positioning the oil shield beneath an oil draining orifice of a motor vehicle;
capturing discharged oil through an open top of the oil shield;
shielding against oil splatter using a face disposed on one side of the open top;
directing flow of captured oil through a hollow handle;
monitoring oil level through the body; and
measuring a collected oil volume using a measurement marking on the body.

20. The method of claim 19, further comprising pouring collected oil through a spout for disposal.
